(19) United States
(12) Patent Application Publication
(10) Pub. No.: US 2011/0302045 A1
(43) Pub. Date: Dec. 8, 2011

(54) AUTOMATIC PATENT TRANSACTION SYSTEM

(75) Inventors: Chen-Yi LEE, Hsinchu City (TW); Ching-Yao Huang, Hsinchu City (TW); Chih-Hua Chang, Hsinchu City (TW); Chih-Wei Wu, Hsinchu City (TW); I-Ju Wu, Hsinchu City (TW); Hsin-Chuh Lu, Hsinchu City (TW); Ya-Hui Lee, Hsinchu City (TW); Yi-Wen Chen, Hsinchu City (TW); Ju-Chuan Chien, Hsinchu City (TW)

(73) Assignee: National Chiao Tung University, Hsinchu City (TW)

(21) Appl. No.: 13/151,360

(22) Filed: Jun. 2, 2011

(30) Foreign Application Priority Data
Jun. 4, 2010 (TW) 099118034

(51) Int. Cl. G06Q 30/00

(52) U.S. Cl. 705/26.2

(57) ABSTRACT

The invention discloses an automatic patent transaction system. The invention comprises a patent database, a member database, a match computing device, a share computing device, a non-member database, and a licensing and transacting computing device. The operation method of the invention also comprises a method for the participation of member and non-member, and a method for the participation of member only. Thus, the invention is able to increase the trade efficiency of the patent and reduce the trade cost of the patent.

### BACKGROUND OF THE INVENTION

1. Field of the Invention

The invention discloses a patent transaction system, particularly an automatic patent transaction system for using the computing technique.

2. Description of the Prior Art

With the rapid development of the economy of countries in all over the world, the demand for the patent technology is increased greatly in various industries. However, in fact, the industries are still hard to obtain their required patent technology. Though the required patent technology can be obtained sometimes, it is necessary to spend the cost of a large amount of manpower and material resources to obtain the new patent technology. Especially for the manufacturer needing to introduce new patent technology, it is undoubtedly a quite formidable operating cost. As for the technology importing countries, it is often more unable to obtain the required patent technology promptly and efficiently, which is also a serious damage to the overall national power.

Taking a broad view of the world, the total amount of patents of various countries are already reached to 40 million at present. It is has already exceeded 30 million in European Union, and reached to more than 7 million in the United States. The amount of pending patent is still increasing continuously. The total amount of patents is reaching to 50 million rapidly all over the world. However, it still lacks the effective patent transaction platform between the demand and supply of patent. Especially there is no convenient, automatic, and easy operating patent transaction platform at present. It even lacks the automatic patent transaction platform for the matching of patent supply and patent demand.

Although there are so many patent supplies in the whole world, the big international pharmaceutical factories, such as Pfizer and Merck, still invested lots of money for the research and development of new medicine in the recent decade. Though the expenses exceeded the total production output value of many countries, the achievement was not good compared to the large input of manpower and financial resources. The payback rate of investment on the research and development has already descended to incredible low, and the number of granted new medicine has already dropped every year. It might be better to carry out the technology transfer from the other small companies, or buy the existing technology to strengthen the product line, which might be able to save the cost and create larger profit. Thus, these big international pharmaceutical factories might probably introduce a half of product line from the outside company in the future. In other words, even the big transnational pharmaceutical factories in the medical field have to introduce the external patent technology in order to meet their demand, thus the patent trade really has its demand. If it is seen from the market, the scale of patent trade is increasing year by year.

And though some relevant intellectual property service mode attempted to provide the assistance on the patent trade in the past, but they did not have the function of automatic patent transaction platform, and there were the following shortcomings:

The patent service provided by the patent sector is comparatively alone and comparatively fragment, namely there is only one-sided information. It is only able to provide the service to some specific demands, and it is unable to provide the overall and whole patent information.

Most patent information service should rely on the conventional artificial way, and it is not the information-based platform. The knowledge experience is unable to be accumulated and used extensively. A large amount of intellectual property information and documents are unable to be treated automatically, namely the integrated and automatic patent transaction platform has not be seen so far.

Thus, in order to generate more efficient patent transaction platform, and provide perfect service to the enterprises, it is necessary to research and develop a new automatic patent transaction platform, so as to increase the trade efficiency of patent transaction platform and reduce the trade cost.

### SUMMARY OF THE INVENTION

The invention provides an automatic patent transaction system. The invention comprises a patent database, a member database, a match computing device, a share computing device, a non-member database, and a licensing and transacting computing device.

The invention discloses the operation method of an automatic patent transaction system, comprising: input a plurality of patents into a patent database; store the plurality of patents; transfer the plurality of patents to a match computing device; provide a plurality of customer information to the match computing device; transfer the plurality of patents and the plurality of customer information to a share computing device; transfer the plurality of patents and the plurality of customer information computed by the share computing device to a licensing and transacting computing device for the computation; and transfer a plurality of non-member information to the licensing and transacting computing device.

The invention discloses the operation method of an automatic patent transaction system, comprising: input a plurality of patents into a patent database; store the plurality of patents; transfer the plurality of patents to a match computing device; provide a plurality of customer information to the match computing device; transfer the plurality of patents and the plurality of customer information to a share computing device; and transfer the plurality of patents and the plurality of customer information computed by the share computing device to a licensing and transacting computing device for the computation.

The invention uses the automatic module to substitute the conventional “artificial” trade service, so that the acquisition of patent would not be restricted by the time and space.

The transaction system of the invention integrates the cloud computing technology to provide the transaction mechanism, in order to reduce the whole trade cost, and increase the chance of successful trade.

The invention promotes the patent research and development group or the relevant patent service group to increase the efficiency and profession through the integrated service platform, and promote the application of the intellectual property, and can raise the competitiveness of the research and development type enterprises.

The invention can prevent the enterprises from the restriction of technology and experience, which can obtain the required patent knowledge service from this platform and accelerate circulation and use of the patent.

The invention can reduce the repeated development cost and shorten the design schedule, reduce the trade cost between patent supplier and user greatly, and help the industry to raise the technique level and competitiveness.

Therefore, the advantage and spirit of the invention can be understood further by the following detail description of invention and attached figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a first embodiment of an automatic patent transaction system of the invention.

FIG. 2 is a schematic diagram showing a second embodiment of an automatic patent transaction system of the invention.

FIG. 3 illustrates the flow chart of the first method for the operation of an automatic patent transaction system of the invention.

FIG. 4 illustrates the flow chart of the second method for the operation of an automatic patent transaction system of the invention.

### DESCRIPTION OF THE PREFERRED EMBODIMENT

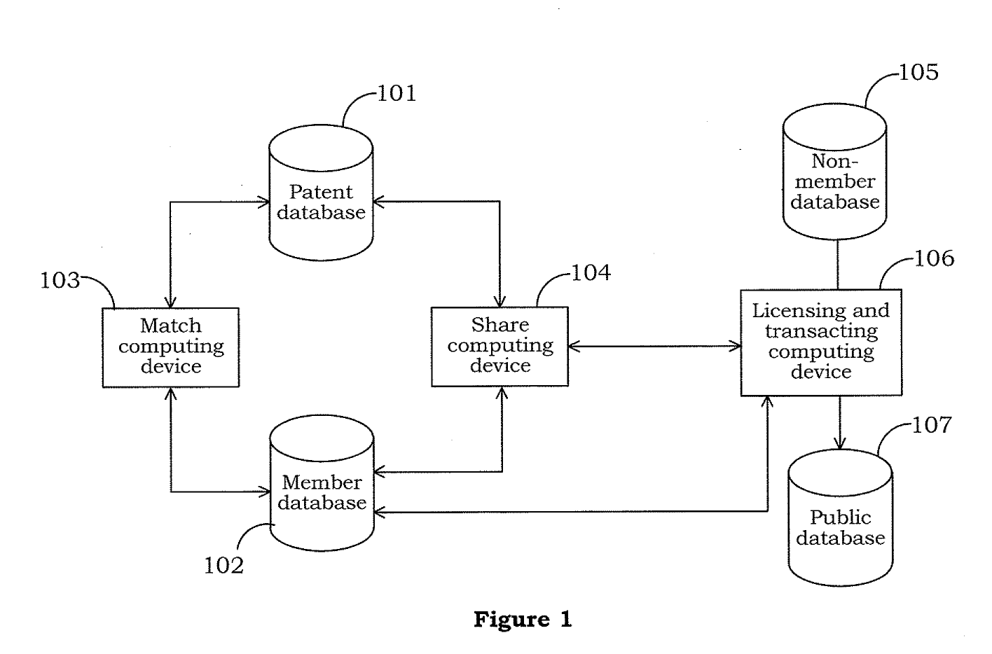

The invention discloses a first embodiment of an automatic patent transaction system. As shown in FIG. 1 first, it comprises a patent database 101, a member database 102, a match computing device 103, a share computing device 104, a non-member database 105, a licensing and transacting computing device 106, and a public database 107.

As shown in FIG. 1, the patent database 101 is connected to the match computing device 103 and the share computing device 104. The member database 102 is connected through the match computing device 103 and the share computing device 104. The share computing device 104 is connected to the licensing and transacting computing device 106. The licensing and transacting computing device 106 is connected to the non-member database 105 and the public database 107. The licensing and transacting computing device 106 is connected to the member database 102.

In the FIG. 1, the function of the patent database 101 is to supplement a plurality of newly-generated patent information at any time, namely to store the patents which are pending and granted, and to hold newly-generated patents and pending patents constantly, and even can move the unnecessary patents.

In the FIG. 1, the function of the member database 102 is to store a plurality of registered customer information. The member may be individual, manufacturer or legal authority. As for the settlement of membership stored in the member database 102, a specific membership due has to be paid to become a member, and it must be the paid member system. If the member needs to buy the patent, the various states of patent can be obtained from the whole patent database 101. The suitable patent can be found through the transaction platform by considering the way of patent licensing or across licensing. At this moment, only the members have the right to inquire the patent information in the patent database 101, so as to ensure the right of members.

In the FIG. 1, the function of the match computing device 103 is to match the mutual information between the patent database 101 and the member database 102, to carry out the interaction between the patent and the customers, and to provide the patent information to the end customer of the member database 102.

In the FIG. 1, the function of the share computing device 104 is to ask the patent database 101 to provide newer patent information after the patent information of the patent database 101 and the member information of the member database 102 are inputted. It can also provide a plurality of patents for the bidding by the members, and notify the result of selected patent to the licensing and transacting computing device 106.

In the share computing device 104 shown in the FIG. 1, it can store and carry out following information operation, and provide the member of the member database 102 by the non-exclusive licensing method. It is able to implement the patents (including the owned patents, or the specific patents, or the classified patents, or the selected patents) in the patent database 101. The implementation period can also be set, such as set in half a year, a year, or one and a half years. The member can also use the patent in the patent database 101 for the lawsuit activity, such as propose the lawsuit to the direct infringer, or provide the defense for accusing the infringement.

In the FIG. 1, the function of the non-member database 105 is to store a plurality of non-member information. The non-member may be individual, manufacturer or legal authority. The non-members of the non-member database 105 are the ones who join at back end at this moment, thus they do not have better choice chances than the member on the preferential right for choosing the patent. The non-members must pay more fees to participate in the follow-up competitive bidding activity.

In the FIG. 1, the function of the licensing and transacting computing device 106 is to notify the share computing device 104 to carry out the competitive bidding of the patent (including the licensing and transacting mode) after receiving the information from the share computing device 104 and the non-member database 105, and can also send the unauthorized and transacted patent information to the public database 107.

In the licensing and transacting computing device 106 shown in the FIG. 1, it can provide the member and non-member to continue on patent competitive bidding activity as the patent exclusive licensing or patent assignment (transaction trade). It means when the member or non-member set the bidding price for the patent exclusive licensing or patent assignment (transaction trade), the licensing and transacting computing device 106 will show all bidding prices of the patent competitive bidding publicly. Thus all members and non-members can know the price of the patent competitive bidding, in order to reach the purpose of justice, fair, open. Especially for the right guarantee of the member, except it can set a certain period in the share computing device 104 for implementing the non-exclusive licensing, the patent competitive bidding qualification as the patent exclusive licensing or patent assignment (transaction trade) can be established directly in the licensing and transacting computing device 106, and there is the discount on the bidding price for the tender participating in the patent competitive bidding. In addition, the member or non-member can participate in the patent competitive bidding activity as the patent exclusive licensing or patent assignment. These two options have to meet the legal provisions of government, including the Basic Scientific and Technological Law (Taiwan), the Government Scientific Research and Development Achievement and Application Rules (Taiwan), and the regulation of Government Property Law (Taiwan) etc. However, the non-member must pay higher fee to participate in the patent competitive bidding and obtain the patent exclusive licensing or patent assignment right.

In the FIG. 1, the function of the public database 107 is to store the patent information of the licensing and transacting computing device 106, and can be used for the public inquiry externally.

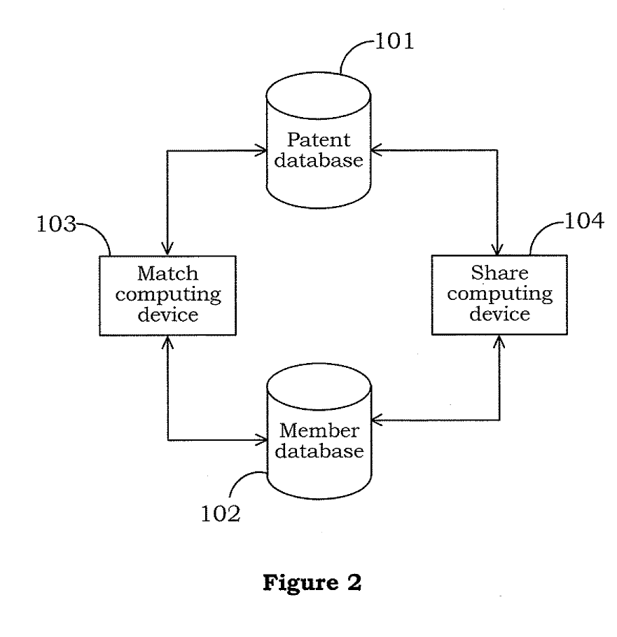

The invention discloses a second embodiment of an automatic patent transaction system. As shown in FIG. 2, it comprises a patent database 101, a member database 102, a match computing device 103, and a share computing device 104.

As shown in FIG. 2, the patent database 101 is connected to the match computing device 103 and the share computing device 104. The member database 102 is connected through the match computing device 103 and the share computing device 104.

In the FIG. 2, the function of patent database 101 is to supplement a plurality of newly-generated patent information at any time, namely to store the patents which are pending and granted, and to hold newly-generated patents and pending patents constantly, and even can move the unnecessary patents.

In the FIG. 2, the function of member database 102 is to store a plurality of registered customer information. The member may be individual, manufacturer or legal authority. If the member needs to buy the patent, the various states of patent can be obtained from the whole patent database 101.

The suitable patent can be found through the transaction platform by considering the way of patent licensing or mutual licensing. At this moment, only the members have the right to inquire the patent information in the patent database 101, so as to ensure the right of members.

In the FIG. 2, the function of match computing device 103 is to match the mutual information between the patent database 101 and the member database 102, to carry out the interaction between the patent and the customers, and to provide the patent information to the end customer of the member database 102.

In the FIG. 2, the function of the share computing device 104 is to ask the patent database 101 to provide newer patent information after the patent information of the patent database 101 and member information of the member database 102 are inputted. It can also provide a plurality of patents for the bidding by the members, including the owned patents, or the specific patents, or the classified patents, or the selected patents.

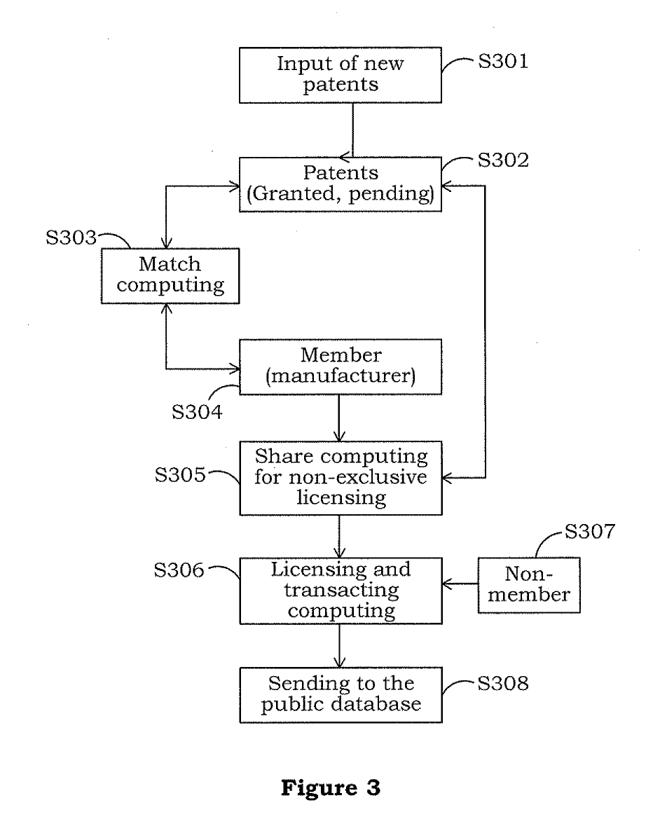

FIG. 3 shows the flow chart of the first method. The operation method of an automatic patent transaction system is conducted under the involvement of member and non-member, and the detailed state is described as follows:

As shown in Step S301 of FIG. 3 (also refer to the systematic diagram of FIG. 1), inputting a plurality of the pending patents and granted patents into the patent database 101. Due to the patents are generated at any time, thus the main purpose of this step is to supplement a plurality of newly-generated patent information into the patent database 101 at any time.

As shown in Step S302 of FIG. 3, storing a plurality of patents into the patent database 101 is carried out.

As shown in Step S303 of FIG. 3, transmitting a plurality of patents stored in patent database 101 to the match computing device 103.

As shown in Step S304 of FIG. 3, provide a plurality of customer information of the member database 102 to the match computing device 103 for matching the customer information and a plurality of patents. The member in member database must pay the fair to obtain the membership at this moment.

As shown in Step S305 of FIG. 3, a plurality of patent information in the patent database 101 and a plurality of customer information in the member database 102 are sent to the share computing device 104 for computing. At this moment, the share computing device 104 can notify the member to carry out the patent non-exclusive licensing, namely the member can implement the patent of patent database 101 within a definite period, so that the member can select whether to obtain the patent non-exclusive licensing.

Especially, at this moment, a plurality of members in the member database 102 can select the patent for the patent competitive bidding in priority. For example, the members can direct against all patents or specific patent, or classified patent in the patent database for implementing them by non-exclusive licensing way, and consider to participating in the follow-up patent competitive bidding after half a year, a year, or one and a half years. The main patents are the granted patents, also including the pending patents. Especially the right of members is the non-exclusive licensing in certain period, the members have the patent competitive bidding qualification as the patent exclusive licensing or patent assignment, and there is the discount on the bidding price for the tender.

As shown in Step S306 of FIG. 3, a plurality of patent information in patent database 101 and a plurality of customer information in the member database 102 are sent to the licensing and transacting computing device 106 after they are computed in the share computing device 104, namely a plurality of members in the member database 102 can participate in the patent competitive bidding.

As shown in Step S307 of FIG. 3, the non-members in non-member database 105 can also be sent to the licensing and transacting computing device 106 for carrying out the selection of patent licensing and patent assignment, namely the non-members can carry out the competitive bidding of individual case. However, as for the patent prior selection right, the non-members can only carry out the competitive bidding of individual case without better selection opportunity than the members.

As shown in Step S308 of FIG. 3, the unauthorized and remised patents are sent to the public database 107 for storing through the licensing and transacting computing device 106. At this moment, the patents become public information for public inquiry.

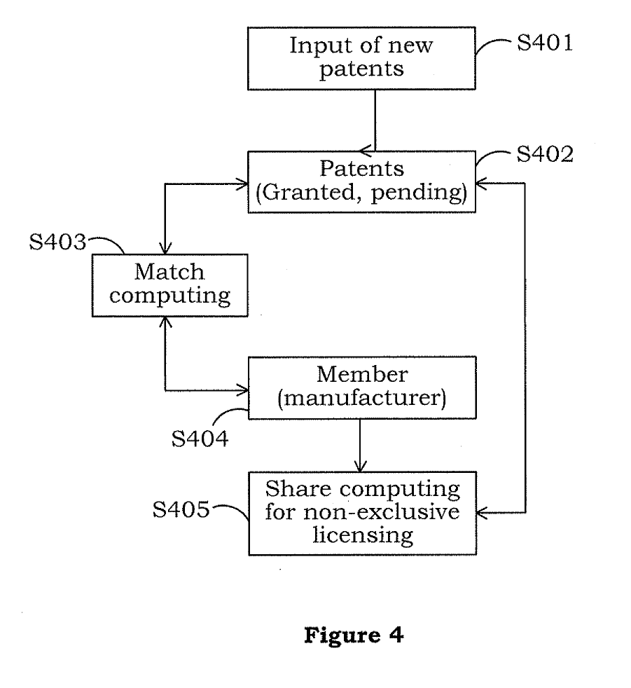

FIG. 4 shows the flow chart of the second method. The operation method of an automatic patent transaction system is conducted under the involvement of member only, and the detailed state is described as follows:

Refer to FIG. 2, as shown in Step S401 of FIG. 4, inputting a plurality of pending patents and granted patents into the patent database 101. Because the patents are generated at any time, so the main purpose of this step is to supplement a plurality of newly-generated patent information into the patent database 101 at any time.

As shown in Step S402 of FIG. 4, storing a plurality of patents into the patent database 101 is carried out.

As shown in Step S403 of FIG. 4, transmitting a plurality of patents stored in patent database 101 to the match computing device 103.

As shown in Step S404 of FIG. 4, provide a plurality of customer information of the member database 102 to the match computing device 103 for matching the customer information and a plurality of patents. The member in member database must pay the fair to obtain the membership at this moment.

As shown in Step S405 of FIG. 4, a plurality of patent information in the patent database 101 and a plurality of customer information in the member database 102 are sent to the share computing device 104 for computing. At this moment, the share computing device 104 can notify the member to carry out the patent non-exclusive licensing, namely the member can implement the patent of the patent database 101 within a definite period.

Especially at this moment a plurality of members can select the patent for the patent competitive bidding in priority. For example, the members can direct against all patents or specific patent, or classified patent in the patent database for implementing them by non-exclusive licensing way, and consider to participating in the follow-up patent competitive bidding after half a year, a year, or one and a half years. The main patents are the granted patents, also including the pending patents. Especially the right of members is the non-exclusive licensing in certain period, the members have the patent competitive bidding qualification as the patent exclusive licensing or patent assignment, and there is the discount on the bidding price for the tender.

The invention uses the computing technique as the core transaction computing technique, including the computer processing device, or internet network, or cloud computing etc. These computing techniques have quick computing and can store a large number of information, which can expand the computing range and computing speed of patent trade, and increase the matching speed of buyer and seller.

The invention discloses a patent transaction system, particularly an automatic patent transaction system for using the non-exclusive licensing state. The purpose is to activate the sufficient implementation of patent right, especially to aim for the authorities or manufacturers with a fairly large number of the pending or granted patents, in order to shorten the licensing time of patents, and preventing the patent classification, patent evaluation, patent packaging, or other complicated management process.

The invention discloses a patent transaction system, particularly an automatic patent transaction system with the patent exclusive licensing or patent assignment state. The purpose is to activate the utilization of the patent industry, and screen out the valuable patent. At the same time, it can be used to assess whether the patent right should be safeguarded continuously, in order to decide whether the annual fee of patent membership would be paid. Especially as for the authorities, schools or manufacturers which pay expensive patent fee every year, it can be used as a reference index for effective cost control and industrialization of the research and development achievement.

Any member (or any non-member) of the invention can send the demand of licensing and transacting into the licensing and transacting computing device. After the notice is received, the licensing and transacting computing device will notify the share computing device to ask for the relevant patent information and notify the member (or non-member) for generating the trade, let other members (or non-members) can join the competitive bidding of the trade, and carry out the competitive bidding in the licensing and transacting computing device, so that the trade can become the exclusive licensing or assignment behavior.

The invention provides an integrated service instead of the previous disperse and loose patent trade service. An automatic patent transaction system is established. As for the enterprises to the patent demand and confidential request, raise the trade efficiency of patent through the automatic matching function, and make the source of patent technology source more abundant.

It is understood that various other modifications will be apparent to and can be readily made by those skilled in the art without departing from the scope and spirit of the invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which the invention pertains.

What is claimed is:

1. An automatic patent transaction system, comprising:
a patent database means for storing, increasing and removing a plurality of patent information;
a member database means for storing a plurality of member information;
a match computing device means for matching a mutual information between the patent database and the member database;
a share computing device means for asking the patent database to provide a newer patent information after the patent information of the patent database and the member information of the member database being inputted;
a non-member database means for storing a plurality of non-member information; and
a licensing and transacting computing device means for notifying the share computing device to carry out a patent trade after receiving an information from the member database and the non-member database, wherein the patent database being connected to the match computing device and the share computing device, the member database being connected through the match computing device and the share computing device, the share computing device being connected to the licensing and transacting computing device, the licensing and transacting computing device being connected to the non-member database, and the licensing and transacting computing device being connected to the member database.

2. The system according to claim 1, wherein the plurality of patent comprises a granted patent.

3. The system according to claim 1, wherein the plurality of patent comprises a pending patent.

4. The system according to claim 1, wherein a specific membership due comprises being paid to become a member.

5. The system according to claim 1, wherein the share computing device, comprising:
providing a specific patent to a member in a member database; and
setting the member of the member database to implement a specific patent by a non-exclusive licensing way in an effective specific period.

6. The system according to claim 5, wherein the implementation period is selected from the group consisting of half a year, a year, and one and a half years.

7. The system according to claim 5, wherein the specific patent is selected from the group consisting of owned patents, specific patents, classified patents, and selected patents.

8. The system according to claim 5, wherein the licensing and transacting computing device provides the member and the non-member to carry out a patent assignment.

9. The system according to claim 5, wherein the licensing and transacting computing device provides the member and non-member to carry out a patent exclusive licensing.

10. An automatic patent transaction system, comprising:
a patent database means for storing, increasing and removing a plurality of patent information;
a member database means for storing a plurality of member information;
a match computing device means for matching a mutual information between the patent database and the member database; and
a share computing device means for asking the patent database to provide a newer patent information after the plurality of patent information of the patent database and the plurality of member information of the member database being inputted, wherein the patent database being connected to the match computing device and the share computing device, the member database being connected through the match computing device and the share computing device.

11. The system according to claim 10, wherein the plurality of patent comprises a granted patent.

12. The system according to claim 10, wherein the plurality of patent comprises a pending patent.

13. The system according to claim 10, wherein a specific membership due comprises being paid to become a member.

14. The system according to claim 10, wherein the share computing device, comprising:
providing a specific patent to a member in a member database; and
setting the member of member database to implement the specific patent by a non-exclusive licensing way in an effective specific period.

15. The system according to claim 14, wherein the implementation period is selected from the group consisting of half a year, a year, or one and a half years.

16. The system according to claim 14, wherein the specific patent is selected from the group consisting of owned patents, specific patents, classified patents, and selected patents.

17. The system according to claim 14, wherein the licensing and transacting computing device provides the member and the non-member to carry out a patent assignment.

18. The system according to claim 14, wherein the licensing and transacting computing device provides the member and the non-member to carry out a patent exclusive licensing.

19. An operation method of an automatic patent transaction system, comprising:
inputting a plurality of patent into a patent database;
storing the plurality of patent in the patent database;
transferring the plurality of patent stored in the patent database to a match computing device;
providing a plurality of member information of a member database to the match computing device, in order to match the plurality of members and the plurality of patents to generate a matching information, and notifying the matching information to the member database and the patent database;
transferring a plurality of patents of the patent database and a plurality of the member information of the member database to a share computing device for assessing the plurality of patents by the plurality of members, and the share computing device notifying the plurality of members for carrying out a non-exclusive licensing; and
transferring a plurality of patents of the patent database and a plurality of the member information of member database computed by the share computing device to a licensing and transacting computing device for computing, and the plurality of members carrying out a patent prior selection.

20. The method according to claim 19, wherein the members comprises determining whether to obtain the patent non-exclusive licensing.

21. The method according to claim 19, wherein after carrying out the patent prior selection, the plurality of non-members in the non-member database being sent to the licensing and transacting computing device for carrying out a selection of a patent licensing and a patent assignment.

22. The method according to claim 19, wherein the plurality of patents comprises a granted patent.

23. The method according to claim 19, wherein the plurality of patents comprises a pending patent.

24. An operation method of an automatic patent transaction system, comprising:
inputting a plurality of patents into a patent database;
storing the plurality of patents in the patent database;
transferring the plurality of patents stored in the patent database to a match computing device;
providing a plurality of member information of member database to the match computing device, in order to match the plurality of members and the plurality of patents to generate a matching information, and notifying the matching information to the member database and the patent database; and
transferring a plurality of patents of the patent database and a plurality of member information of the member database to a share computing device for assessing the plurality of patents by the plurality of members, and the share computing device notifying the plurality of members for carrying out non-exclusive licensing.

25. The method according to claim 24, wherein the share computing device notifying the plurality of members for carrying out the non-exclusive licensing comprises determining whether to obtain the patent non-exclusive licensing.

26. The method according to claim 24, wherein the plurality of patents comprises a granted patent.

27. The method according to claim 24, wherein the plurality of patents comprises a pending patent.
